(19) United States
(12) Patent Application Publication
(10) Pub. No.: US 2017/0360537 A1
(43) Pub. Date: Dec. 21, 2017

(54) Fluid Dental Pick

(71) Applicant: Lisa Landau, Huntington Beach, CA (US)

(72) Inventor: Lisa Landau, Huntington Beach, CA (US)

(21) Appl. No.: 15/629,645

(22) Filed: Jun. 21, 2017

Related U.S. Application Data
(60) Provisional application No. 62/352,984, filed on Jun. 21, 2016.

(51) Int. Cl. A61C 17/02; A61C 15/00

(52) U.S. Cl. CPC A61C 17/0202; A61C 15/00

(57) ABSTRACT

A fluid emitting dental pick device for cleaning is having a handle defined by a body having an interior cavity. A pick component engaged to one end of the body bifurcates a pressurized fluid stream into two individual fluid streams projecting in opposing directions to clean both sides of the teeth concurrently. An optional reservoir holding a secondary fluid can also be employed which mixes fluid from the reservoir into the pressurized fluid stream which is delivered to the teeth with the two individual fluid streams.

This application claims priority to U.S. Provisional Patent Application Ser. No. 62/352,984, filed on Jun. 21, 2016, which is incorporated herein in its entirety by this reference thereto.

### BACKGROUND OF THE INVENTION

### 1. Field of the Invention

The present invention relates generally to dental cleaning devices. More particularly, the disclosed device relates to a fluid jet pick device having dual opposing streams which is configured for maximizing bacterial and particle removal from teeth though the communication of pressurized fluid from opposing openings of a pick component during teeth cleaning.

### 2. Prior Art

In modern times, tooth decay and gum infections and diseases have been associated in the cause and progression of not only tooth loss and tooth cavities, but also in many systemic and organ related diseases. For example it has become known that gum infections, which may be primarily caused by plaque deposits and related bacteria, can cause cardiac complications and infections.

In furtherance of reducing gum disease and tooth loss, as well as the systemic spread of bacteria from the mouth, dental professionals have recommended the removal of dental plaque from the surface of teeth on at least a daily basis. Plaque continuously forms one and in-between teeth above and below the gum lines. In addition to harboring bacteria, over time plaque can calcify and form tartar which is a hardened form of plaque.

According to research and dental professionals, daily cleaning around and in-between each tooth helps prevent the calcification of plaque into tartar. Such a cleaning regimen also aids in the prevention of tooth decay and related dental problems.

However, studies show that brushing the teeth and gums with a toothbrush is not sufficient as a means for daily cleaning to remove plaque. However, conventional flossing and cleaning devices lack a construction and function to provide maximum bacterial and plaque removal and therefore, prevent the formation of plaque and tooth decay. Further, the use of dental floss repeatedly can actually cause the spread of mouth bacteria.

More recently, water jet devices have been introduced which use a single stream of water to remove food particles and plaque from the teeth, as well as tooth brushes with vibration or ultrasonic operation. However such devices generally only contact and cleans one side of teeth and gums and require user diligence to clean the inner and outer surfaces of the teeth in the dental arches. Further, they offer no means to effectively communicate cleaners and medication to the gums and teeth in a reliable repeatable fashion.

Provided herein is a system and apparatus which is configured to clean both sides of the teeth and gums concurrently, to aid the user by requiring only a single pass around the dental arch for removal of plaque and food particles and the like. Using a dual jet system communicated at opposing angles, the device imparts fluid under pressure to both sides of the gaps and gums on opposing sides of each tooth around a dental arch. Additionally, the device herein is adapted to apply medication, cleaning solutions, or other medications into both fluid streams to thereby concurrently treat the teeth and gums at the same time.

It should be noted, the forgoing examples of related art and limitations related therewith are intended to be illustrative and not exclusive, and they do not imply any limitations on the oral cleaning device and method described and claimed herein. Various limitations of the related art are already known or will become apparent to those skilled in the art upon a reading and understanding of the specification below and the accompanying drawings.

An object of the present invention is the provision of a fluid cleaning device which communicates opposing fluid streams to both sides of the gums and teeth of a user at the same time.

It is another object of the invention to provide such a fluid cleaning device which also is adapted for adding medications or cleaners or other additives to the opposing fluid streams during use, to allow for the regimented application of such to the teeth and mouth of the user concurrent with the cleaning of teeth and gums with the device.

It is a further object of the invention, to provide such a device which will emit dual fluid streams at opposing angles relative to the axis of the pick component extending from the handle.

Further objectives of this exercise invention will be brought out in the following parts of the specification wherein the summary and detailed description of the invention are for the purpose of fully disclosing the invention without placing limitations thereon.

### SUMMARY OF THE INVENTION

The present invention remedies this long needed solution to the shortcomings in the art of dental hygiene, through the provision of a fluid jet cleaning device configured to communicate concurrent opposing pressurized fluid streams to the teeth and gums of the user. The opposing jet fluid streams can be dispensed concurrently on both sides of a tooth or gap therebetween in a dental arch, at optimum angles of contact with the tooth, gap, or gums of the patient through configuration of the pick component. The device, as configured, will thus concurrently employ dual fluid streams under pressure to clean both sides of the teeth and gums around the dental arches of the user concurrently.

Preferably the two openings emitting the pressurized fluid streams on either side of a gap are formed to emit the fluid streams at opposing angles to the axis of the pick component, which generally follows the axis of the handle. Because the gap in the pick component is engaged to place a jet emitter on both sides of the teeth as it travels around the dental arch, it was originally assumed that opposing 90 degree angles would work best since such would cause the fluid streams to impact with the most contact force against teeth and gums. However, unexpectedly, it was found after additional experimentation with emitters, which were formed at 40 degree angles, that even though the fluid streams impacted with less contact force, they seemed for some reason to remove more plaque and debris.

Additional experimentation confirmed this unexpected result. It was found that forming the opposing pressurized fluid streams to exit on opposite sides of the gap between them, at opposite angles of between 25 to 70 degrees, relative to the axis of the axis of the pick component, removed plaque and debris, and the like, better than a 90 degree angle which was thought originally to be superior. Optimum results appeared at angles between 30-60 degrees relative to the axis of the pick component with a 40-50 degree opposing angle configuration being slightly better. It appeared that a cutting action was provided along with an impact even where the impact force was lower than a 90 degree contact of opposing jet streams. Consequently, opposing angles between 25 to 70 degrees, relative to the axis of the pick component, are preferred with opposing angles in a range between 40-50 degrees relative to the axis being particularly preferred.

In a preferred configuration of the device, there is also included an onboard reservoir engaged or engageable with the handle, for solute which will dissolve into a fluid, or a fluid, which can then be injected into both fluid streams during use for periods of time determined by the user. The reservoir employs a removably engageable fluid housing configured with an interior cavity sized to hold a fluid such as a dental cleaner, a prescription medication, or non prescription medication, or other fluid or dissolved particulate, which can be communicated in the opposing fluid streams to the teeth and gums of the user.

For example, a fluid concentrate of mouthwash could be held in the removable housing reservoir, and then directed by the opposing fluid streams against the gums, gaps, and teeth. Also, a prescription or non prescription medication, adapted for disbursal into the fluid stream communicated to the opposing jets of water or fluid, can be placed in the reservoir of the removable housing and thereafter be used to treat the teeth and gums of the user.

The device features a handle have a curved exterior shape and configuration, with a recessed center area, which is adapted to ergonomically fit the hand of the user holding the device. If onboard electric power is required, the device will include an onboard power supply which may be recharged using a charger such as an induction charger well known in the art to charge electric tooth brushes.

In a particularly preferred mode, the device features an internal fluid flow system, configured to input fluid from a pressurized fluid source such as or similar to a conventional water pick. The incoming pressurized fluid, such as water, is directed along a first conduit for a first fluid stream where it is bifurcated at the distal end of the removably engaged fluid pick component, into two opposing streams of fluid which exit the fluid pick component from opposing openings positioned a distance across a gap which is adapted to allow the insertion of the teeth of the dental arch in-between the gap and the opposing fluid streams.

Also, in a preferred mode of the device, the secondary fluid stream may be communicated into mix with the first fluid stream to communicate a mixture of the two fluid streams from the opposing openings on the pick component. This secondary fluid stream may be drawn into the first fluid stream using an automatic or user operable venturi, or using an automatic or user-actuated valve.

This secondary fluid stream is composed of fluid communicated along a fluid pathway from the reservoir held within the internal cavity of the removably engageable fluid housing. This secondary fluid stream is communicated either to a valve or venturi noted above for mixture into the first fluid stream which is then directed against both sides of the gums and teeth of the dental arch of the user concurrently to both clean and treat both sides of the gums and teeth concurrently.

With respect to the above description, before explaining at least one preferred embodiment of the herein disclosed pressurized fluid dental cleaning and treatment device in detail, it is to be understood that the invention is not limited in its application to the details of construction and to the arrangement in the following description or illustrated in the drawings. The dental hygiene invention herein described, is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other pressurized fluid dental hygiene systems and devices and for carrying out the several purposes of the present disclosed system. It is important, therefore, that the claims herein be regarded, as including such equivalent construction and methodology, insofar as they do not depart from the spirit and scope of the present invention.

### BRIEF DESCRIPTION OF DRAWING FIGURES

FIG. 1 depicts a mode of the device showing input adapted to sealably engage a pressurized fluid source being communicated into the body of the device where internal conduits communicate a first fluid stream to both of two opposing openings on both sides of a gap at the distal end of the engaged pick component.

FIG. 2 depicts a partially exploded view of the device showing the removably engageable fluid housing configured for operative engagement within a recess formed in the handle of the device, whereafter a cover is engaged to the body over the installed fluid housing. Also shown is the preferred fluid stream exit angles relative to the center axis of the pick component.

FIG. 3. shows the first fluid stream from the inlet engaged to a pressurized fluid source and the second fluid stream from the reservoir in the fluid housing which may be mixed using a valve or venturi to exit from opposing openings across a gap at the distal end of the engaged pick component.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms refer to the device or depictions as such may be oriented are describing such as it appears in the drawings and are used for convenience only. Such terms of direction and location are not intended to be limiting or to imply that the device herein has to be used or positioned in any particular orientation.

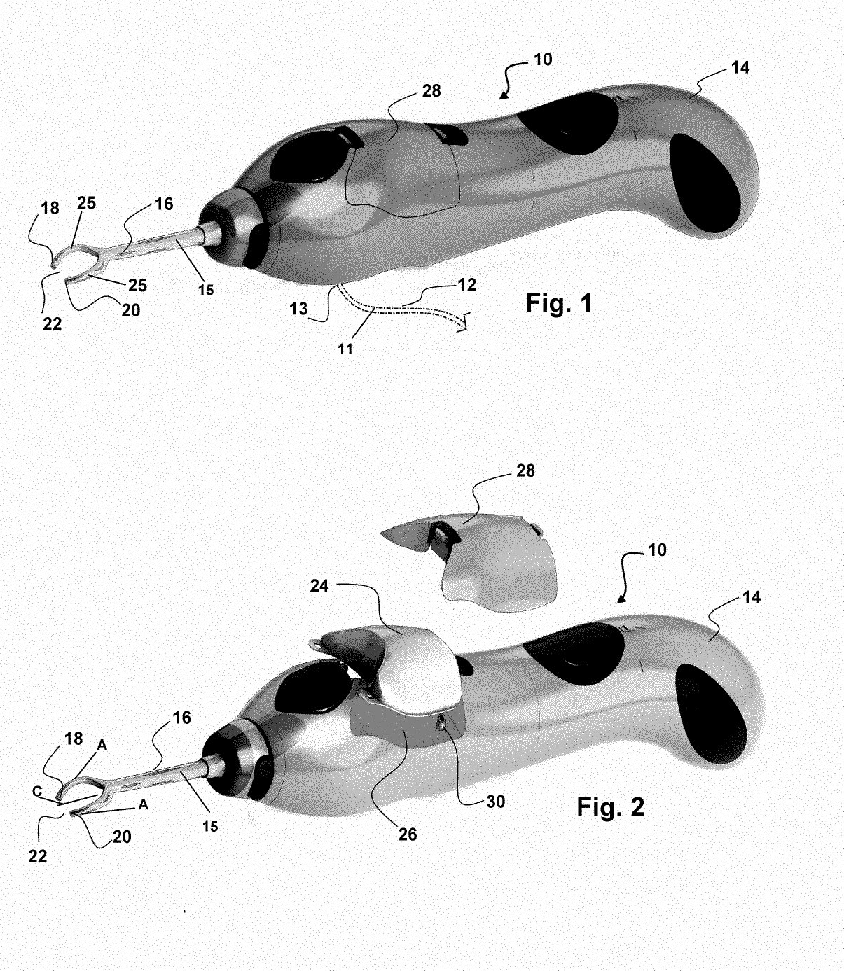

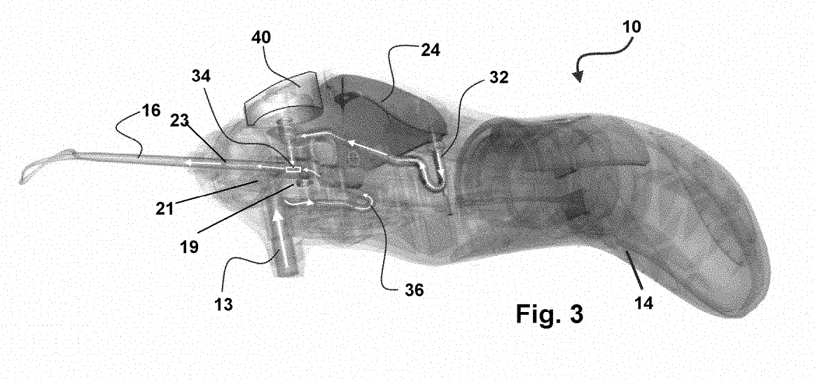

Now referring to drawings in FIGS. 1-3, wherein similar components are identified by like reference numerals, there is seen in FIG. 1, the device 10 configured for use. As can be seen, an input conduit 11 configured to connect to a pressurized fluid source 12 of a pressurized fluid supply, is operatively engaged with an inlet 13 in the body 14 in sealed engagement to a fluid pathway 19 (FIG. 3) running through an interior cavity 21 of the body 14 of the device 10. This fluid pathway 19 in the simplest mode, communicates a first fluid stream from the pressurized fluid source 12, through the fluid pathway 19 to an outlet 23 at a first end of the body 14 and into an axial conduit 15 of the pick component 16 which defines an axis of an engaged pick component 16.

At the distal end of the pick component 16, opposite an engagement end which is removably engageable to the body 14 where the axial conduit 15 in sealed engagement with an outlet 23 of the fluid pathway 19, (FIG. 3). As can be discerned from FIGS. 1-3, the pressurized fluid stream from the fluid pathway 19, is bifurcated and exits under pressure, from the pick component 16, from openings 18 and 20 situated on opposite sides of the gap 22. The fluid exits under pressure in respective fluid streams with a first fluid stream exiting from opening 18 and projecting across said gap 22, and a second fluid stream exiting from opening 20 and projecting in an opposing direction across said gap 22 from the first fluid stream exiting opening 18.

The openings 18 and 20 may be situated on respective forks 25 at the distal end of the pick component 16. The gap 22 between the openings 18 and 20, is adapted to allow for the passage of the teeth and gum line of a user therethrough to position the two opposing 18 and 20 and the respective exiting fluid streams through the openings 18 and 20, on both sides of the teeth and gums of a dental arch of the user during use. In other words, one opening 18 or 20 will be situated on the inside of the dental arch closest to the tongue, and the other opening 18 or 20 will be situated on the outside of the dental arch on an opposite side of the teeth from the tongue.

As noted, preferably the two openings 18 and 20 emitting the respective first and second fluid streams on either side of a gap 22, are formed on the forks 25 or other structures, which are shaped to position the openings 18 and 20, to emit the first and second fluid streams at opposing angles A, to the center axis C of the pick component 16 shown in the gap 22 of FIG. 2. In a preferred mode of the device 10, the shape of two forks 25 at the bifurcated tip at the distal end of the pick component 16, position the openings 18 and 20, to provide the opposing fluid first and second streams exiting from the respective openings 18 and 20, at opposing angles to the axis C of the pick component 16, of between 25 to 70 degrees, relative to the extension of that axis C, as shown in FIG. 2. Particularly preferred are first and second fluid stream opposing angles of between 30-60 degrees and 40-50 degrees. The forks 25 or similar structures can be formed to change this emission angle of the opposing first and second fluid streams, and to adjust the size of the gap 22. Since each fork 25 has an internal conduit between the axial conduit 15 and its respective opening 18 or 20, a curved shape is preferred to maximize the fluid flow therethrough to the respective opening 18 and 20.

The pick component 16 may be removably engageable at the engagement end which is opposite the distal end having the gap 22 therein. In such a removable engagement, the axial passage 15 is placed in a sealed connection to the outlet 23 of the fluid pathway 19 running through the body 14 defining the handle. It may also be from a kit of pick components 16, where each member of the kit including a plurality of pick components 16, having varying with gaps 22, such that it may be changed to provide a pick component 16 with the proper sized gap 22, for a particular user's teeth and gum dimensions, since tooth size varies.

In FIG. 2, as noted, there is shown an exploded view of the device 10 showing the removably engageable fluid housing 24 which is dimensioned for operative positioning within a recess 26 formed in the handle defined by the body 14 of the device 10. A cover 28 is sized and adapted to removable engage with the body 10 and cover over the installed fluid housing 24.

Also shown in FIG. 2 is an in inlet 30 having an internal conduit for a second fluid stream or which is within a section of the fluid pathway 19. In this mode, the inlet 30 is configured for a sealed removable engagement with the fluid housing 24 such that fluid contained in the interior cavity of the fluid housing 24 is communicated into the internal conduit of the inlet 30, and thereafter and into internal conduits of the fluid pathway 19 running within in the body 14 forming the handle. As shown in FIG. 3, the second fluid stream communicates through the second conduit 32 to a venturi or valve 34, where it may be mixed into the first fluid stream running through the fluid pathway 19 carrying pressurized fluid from the pressurized fluid source 12.

FIG. 3 shows the first fluid stream from the inlet 13 engaged with the pressurized fluid source 12 communicating through a first conduit 36 of a fluid pathway 19, which as noted runs through the body 14 defining a handle, and is in fluid communication with the axial passage 15 of the pick component 16 at the engagement end. Fluid, in all modes, is discharged in the opposing pressurized fluid streams, from opposing openings 18 and 20, at the preferred angles relative to the axis of the pick component 16, through a bifurcation of the fluid stream at the distal end of the pick component 16.

The second fluid stream if present, flows from the fluid housing 24 through the second conduit 32 to a junction with the first conduit 36 and into the fluid pathway 19. This junction may be a valve adapted to mix the two fluid streams at a designated ratio, or may be a venturi adapted for such. Alternatively, the mixing of the first fluid stream with the second may be handled by action of the user to press an actuator which will open the valve or venturi at the junction 34, and mix the second fluid stream with the first fluid stream for a discharge of the mixed fluid streams from the opposing openings 18 and 20 for the duration of activation by the user. For example, the actuator 40 may be a depressible button connected by a shaft which opens the valve or actuates the venturi to mix the two fluid streams during actuation.

While all of the fundamental characteristics and features of the fluid pick dental hygiene device and system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful device and system herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A fluid emitting dental pick, comprising:
a handle having a body, said body having a first end opposite a second end and having an exterior surface covering an interior cavity;
a first fluid pathway running through said body from an outlet at said first end to an inlet;
a pick component having an engagement end and a distal end, and having an axial conduit running therethrough defining an axis of said pick component;
said engagement end of said pick component in a sealed engagement with said exit of said first fluid pathway at said first end of said body;
said distal end of said pick component having a first opening and having a second opening and having a gap in-between said first opening and said second opening;
said first opening and said second opening both in a respective communication with said axial conduit;
said inlet of said first fluid pathway engageable with a pressurized fluid supply; and
said first opening emitting a first fluid stream from said pressurized fluid supply, across said gap in a first direction;
said second opening emitting a second fluid stream from said pressurized fluid supply, across said gap in a second direction opposing said first direction of said first fluid stream; and
whereby both sides of teeth positioned within said gap are cleaned by said first and second fluid streams.

2. The fluid emitting dental pick of claim 1, additionally comprising:
said first opening positioned on said distal end to emit said first fluid stream across said gap at an angle between 25-70 degrees relative to said axis of said pick component; and
said second opening positioned on said distal end to emit said second fluid stream across said gap at an angle between 25-60 degrees relative to said axis of said pick component.

3. The fluid emitting dental pick of claim 1, additionally comprising:
said first opening positioned on said distal end to emit said first fluid stream across said gap at an angle between 30-60 degrees relative to said axis of said pick component; and
said second opening positioned on said distal end to emit said second fluid stream across said gap at an angle between 30-60 degrees relative to said axis of said pick component.

4. The fluid emitting dental pick of claim 1, additionally comprising:
said first opening positioned on said distal end to emit said first fluid stream across said gap at an angle between 40-50 degrees relative to said axis of said pick component; and
said second opening positioned on said distal end to emit said second fluid stream across said gap at an angle between 40-50 degrees relative to said axis of said pick component.

5. The fluid emitting dental pick of claim 1, additionally comprising:
said pick component having a first curved fork portion extending between said distal end of said pick component and said first opening; and
said pick component having a second curved fork portion extending between said distal end of said pick component and said first opening.

6. The fluid emitting dental pick of claim 2, additionally comprising:
said pick component having a first curved fork portion extending between said distal end of said pick component and said first opening; and
said pick component having a second curved fork portion extending between said distal end of said pick component and said first opening.

7. The fluid emitting dental pick of claim 3, additionally comprising:
said pick component having a first curved fork portion extending between said distal end of said pick component and said first opening; and
said pick component having a second curved fork portion extending between said distal end of said pick component and said first opening.

8. The fluid emitting dental pick of claim 4, additionally comprising:
said pick component having a first curved fork portion extending between said distal end of said pick component and said first opening; and
said pick component having a second curved fork portion extending between said distal end of said pick component and said first opening.

9. The fluid emitting dental pick of claim 1, additionally comprising:
a fluid housing positioned in said interior cavity;
said fluid housing having a second fluid pathway extending from a reservoir within said fluid housing and said first fluid pathway; and
whereby fluid positioned within said reservoir is communicated through said second fluid pathway to said first fluid pathway and mixed within said pressurized fluid supply.

10. The fluid emitting dental pick of claim 1, additionally comprising:
said sealed engagement of said engagement end of said pick component with said exit of said first fluid pathway at said first end of said body, is a removable engagement.

11. The fluid emitting dental pick of claim 9, additionally comprising:
said sealed engagement of said engagement end of said pick component with said exit of said first fluid pathway at said first end of said body, is a removable engagement.

12. The fluid emitting dental pick of claim 10, additionally comprising:
said pick component being one of a plurality of removably engageable pick components.

13. The fluid emitting dental pick of claim 11, additionally comprising:
said pick component being one of a plurality of removably engageable pick components.
